(19) United States
(12) Patent Application Publication
(10) Pub. No.: US 2013/0268304 A1
(43) Pub. Date: Oct. 10, 2013

(54) Systems, Methods, and Computer Program Products for Purchasing Transportation Tickets

(71) Applicant: Kalpesh Ashok Doshi, San Jose, CA (US)

(72) Inventor: Kalpesh Ashok Doshi, San Jose, CA (US)

(21) Appl. No.: 13/852,911

(22) Filed: Mar. 28, 2013

Related U.S. Application Data
(60) Provisional application No. 61/622,291, filed on Apr. 10, 2012.

(51) Int. Cl. G06Q 10/02

(52) U.S. Cl. CPC G06Q 10/02
USPC 705/5

(57) ABSTRACT

A system includes a memory storing user account information, wherein the information comprises an account identifier for a user; and one or more processors for determining a transportation station for a user based on a determined location of the user through a user mobile device; determining a direction of travel by the user; presenting a list of destinations to the user mobile device, the list of destinations being associated with a travel schedule corresponding to the transportation station and the direction of travel; receiving a selected destination from the list via the user mobile device; and presenting a ticket to the user mobile device, the ticket corresponding to the selected destination.

### RELATED APPLICATION

The present application claims the benefit of U.S. Provisional Patent Application No. 61/622,291, filed Apr. 10, 2012, and entitled “Train Ticket Purchase Using Augmented Reality,” the disclosure of which is incorporated by reference herein in its entirety.

### BACKGROUND

1. Technical Field

The present disclosure generally relates to purchasing transportation tickets and, more specifically, to using a mobile device to purchase tickets.

2. Related Art

Train travelers typically have to purchase tickets from a ticketing terminal or kiosk at a train station or light rail stop. Such travelers face multiple problems, such as reaching the station just when the train is about to leave and missing the train because they have to buy a ticket, standing in line to purchase tickets during rush hour, not having the cash to purchase a ticket, etc. There is currently no more convenient technique to purchase tickets.

### BRIEF DESCRIPTION OF THE DRAWINGS

FIG. 1 is a block diagram illustrating an example system for transmission of funds from a transmitter to a receiver over a network, according to one embodiment.

FIG. 2 illustrates example method, adapted according to one embodiment, for purchasing tickets according one embodiment.

FIG. 3 is an illustration of an example user interface adapted according to one embodiment.

FIG. 4 is an illustration of an example augmented reality interface adapted according to one embodiment.

FIG. 5 is an illustration of an example electronic ticket displayed upon a screen of a user mobile device according to one embodiment.

FIG. 6 is a block diagram of a computer system suitable for implementing various methods and devices described herein.

FIG. 7 is a simplified block diagram of an example electronic device on which a human user may interact with a ticket purchasing system according to one embodiment.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting.

According to the various aspects of the present disclosure, a payment service provider, such as PayPal, Inc. of San Jose, Calif., allows a user or traveler to purchase a ticket while on the train through the user's mobile device, such as a smart phone or computing tablet. The user's mobile device includes a mobile application (App) that utilizes augmented reality, such as the web utility or application available from the Layar company. The user launches the app, which then determines the direction of travel for the user. This can be done in several ways.

In one example, the user points the mobile device in the direction of travel. The app can detect this direction, e.g., West, South, East, North, Northwest, Southwest, Southeast, Northeast, etc. In another example, the mobile device can determine the direction of travel by the motion of the mobile device. If the user is moving in a westward direction, such as on a moving train, the system determines that the direction of travel is the same as the direction of the device movement. In yet another example, the user may manually, either through text or voice, enter a direction of travel through the user mobile device. In this case, the user may enter a location along the direction of travel or enter a specific compass direction. For example, the user may enter a city along the direction of travel, which may be the final destination or just a city along the direction of travel. The payment service provider system or server may determine the direction of travel based on the direction from the current user location, such as determined by GPS capabilities within the mobile device, to the entered city. Note that the user location may be determined when the app is launched or at any time before or after.

The above is not exhaustive and other means of determining a direction of travel may be possible. Furthermore, combinations of one or more of the above may be used by the payment service provider. For example, a direction of travel may be determined using a combination of the user pointing the mobile device in direction of travel and the system/service detecting a direction of movement of the user device.

Once a direction of travel is determined, the system may access a train schedule of the train station at the user's current location. For example, the system or payment service provider may determine that the user is at a location corresponding to station 9 of a public transit train. The direction of travel is determined, such that the train at station 9 will be going to stations 10, 11, 12, etc., as opposed to stations 9, 8, 7, etc. in the opposite direction. The payment service provider may then present, on the user's mobile device, the train schedule for the train route going to stations 10, 11, 12, etc. from station 9. The schedule may be interactive to allow the user to select a desired station for travel. The user may see fares associated with each station, along with departure/arrival times and any transfers to other trains along the route.

The user may select the desired stop from the mobile device, such as by tapping on the station or selecting a box or field associated with the desired station. The user may be asked to confirm the selection.

Once confirmed, the payment provider may process a purchase of the ticket or fare. If not already authenticated, the user may be asked for authenticating information, such as a password/PIN and possibly a user identifier, such as an email address, user name, or phone number.

The user may then indicate a desire to purchase the ticket, such as by selecting a purchase or buy button/link on the user device. The user may first see a screen with details of the ticket purchase, such as from station 9 to the desired station. Once selected, the payment service provider may debit an account of the user with the payment service provider and credit an account of the train service. If successful, the payment service provider may send a notification to the user and/or the train service. For example, the user may be sent an electronic ticket, which can be displayed on the user device for scanning or presentment to a train ticket agent or electronic ticket scanner. As a result, the user may quickly and easily purchase a train ticket on the user's mobile device, either before boarding a train or while on a train.

Note that although train ticket purchase is described above, other types of tickets may also be purchased using ideas discussed herein. For example, the user may be able to purchase bus tickets, subway tickets, and other public/private transportation tickets in which tickets are purchased based on where the user is going to. Furthermore, one or more of the various steps described herein may be performed in different sequences, combined, or omitted.

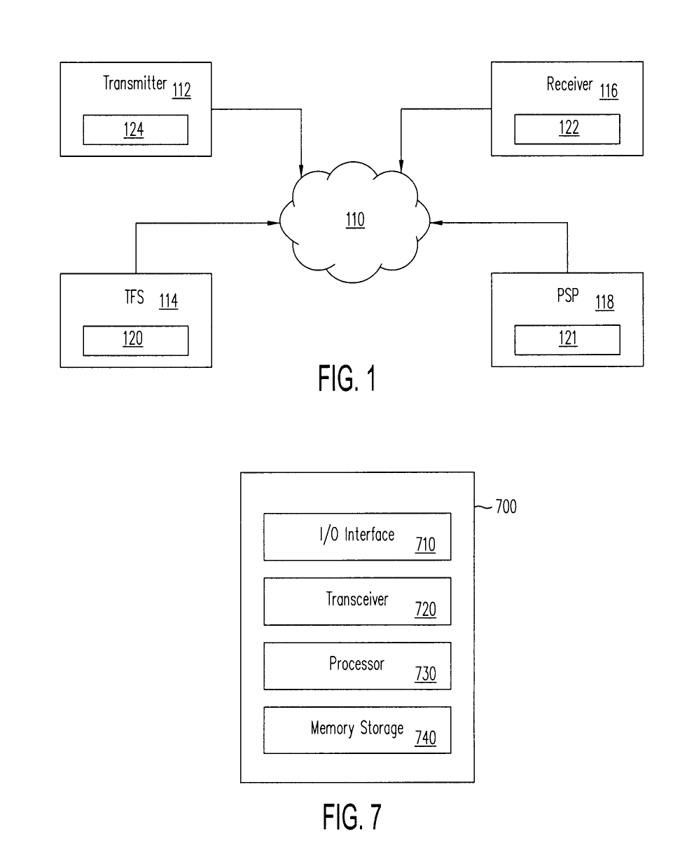

FIG. 1 is a block diagram illustrating an example system 100 for transmission of funds from a transmitter to a receiver over a network 110, according to one embodiment. An example of a transmitter 112 is a customer with an electronic financial account. An example of a receiver 116 is a transportation provider (e.g., a train company or bus company) that receives money from the transmitter 112. In one aspect, the transmitter 112 and the receiver 116 can be electronic devices representing each of the parties to the transaction. In one example, the transmitter 112 includes a smartphone, tablet computer, laptop computer, or the like, operable to interface with the human user (e.g., a train rider), to allow the human user to select tickets, and to display an electronic ticket. In another example, the receiver 116 includes a server or other computer that interacts with the user to present ticket options and to sell the ticket to the user. Receiver 116 may also communicate with PSP 118, e.g., to confirm that payment has been made before issuing a ticket.

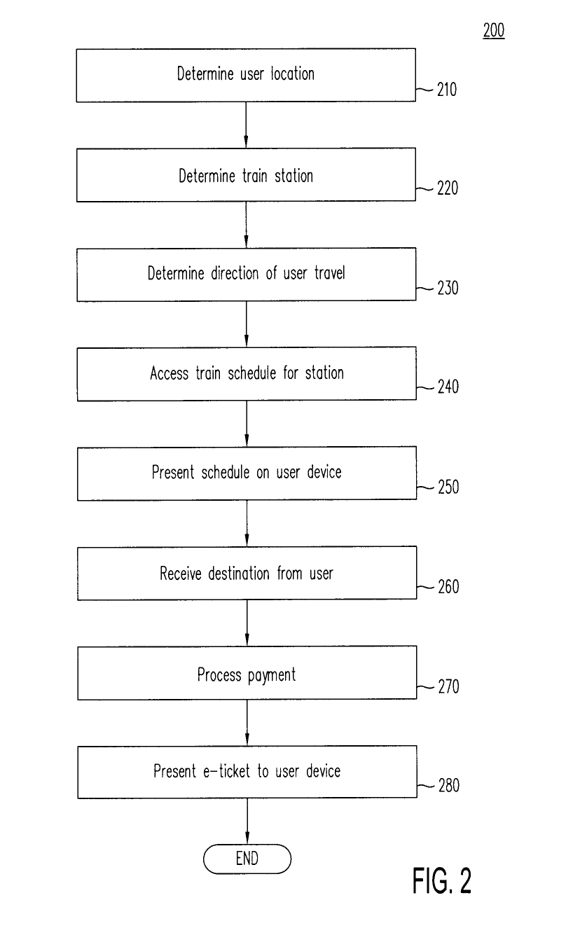

Payment Services Provider (PSP) 118 is a bank or other payment services entity, such as PayPal, Inc., which can send and receive funds and manage accounts. For instance, PSP 118 manages an account 121 for the receiver 116. Transmitter Funding Source (TFS) 114 is also a bank or payment services entity that manages electronic account 120 on behalf of transmitter 112. Ticketing process 122 is a process running on one or more servers and includes functionality according to the actions of FIG. 2. For instance, ticketing process 122 may be a server-side application that communicates with the user's mobile device. Transmitter 112 (or a user mobile device represented thereby) includes a corresponding ticketing process 124 that communicates with ticketing process 122 to allow for location determination, user interface, and ticket-purchasing activities. Ticketing process 124 may be a stand-alone application, a web browser plugin, or other appropriate functionality.

In one payment scenario, the receiver 116 provides TFS information to the receiver's PSP 118 to request the payment from the TFS 114. The PSP 118 includes information about account 121. The PSP 118 communicates with the TFS 114 to facilitate the transfer of funds. In response, TFS 114 provides the payment, or transfer of funds, from account 120 to the receiver PSP 118. This processing may involve other parties during the communication between TFS 114 and PSP 118. The TFS 114 is an electronic system(s) that maintains accounts for users and has capability for communication with electronic systems used by other funding sources and payment service providers. The PSP 118 maintains the receiver's financial account 121, and includes an electronic system for communicating with electronic systems used by other payment service providers. Once the PSP 118 has received the transfer of funds, or a commitment that the funds are scheduled for transfer, the PSP 118 provides a confirmation to the receiver 116.

In another example, PSP 118 includes ticketing process 122 so that transmitter 112 communicates with PSP 118 during the ticket selection and purchase actions. In such an embodiment, PSP 118 may communicate with receiver 116 to coordinate the purchase of tickets during a transaction as appropriate.

In yet another embodiment, PSP 118 includes ticketing process 122, and the human user has an account with PSP 118. In such an embodiment, the human user accesses ticketing process 124, which logs the human user into PSP 118. In such an embodiment, the receiver 116 would not provide the user's TFS information to the PSP 118; instead, PSP 118 would already have transmitter payment information and would handle the transaction for transmitter 112 and receiver 116.

The various components 112-118 communicate with each other over communication network 110, which may include one or more networks, such as a cellular network, the Internet, and the like.

Various embodiments include methods for purchasing tickets using the system shown in FIG. 1. FIG. 2 illustrates example method 200, adapted according to one embodiment, for purchasing tickets according to the principles discussed above. The example of FIG. 2 is from the perspective of ticket purchasing process 122, and the actions of FIG. 2 may be performed by one or more computer processors at PSP 118 and/or receiver 116. One or more computer processors may execute code that provides the functionality described herein.

Beginning with the actions of blocks 210-260 and 280, such actions may be performed with the aid of functionality on the user's mobile device. For instance, in some embodiments, the ticketing functionality 122 that runs on a computer at receiver 116 or PSP 118 performs the actions of blocks 210-260 and 280 at least in part by receiving information via the user's mobile device and/or passing information to the user's mobile device. In some embodiments the actions of blocks 210-260 and 280 may include processing on the part of the ticketing functionality 122 above and beyond simply sending or receiving information. In fact, various embodiments may divide the actions 210-260 and 280 between ticketing process 122 and ticketing process 124 in any appropriate manner.

At block 210, the system determines user location.

In one embodiment, block 210 includes the user's mobile device discerning a longitude and latitude of the mobile device. In such an example the user's mobile device is enabled to the Global Positioning System (GPS) or other satellite-based location service, a GPS receiver built into the mobile device discerns the location of user. The system determines the user location by receiving that information from the user's mobile device.

In another example use case, the user's mobile device may receive location information from an outside source, such as via user input or input from another computing device. The user's mobile device may then pass that information on the ticket purchasing process 122.

At block 220, the system determines a train station at which the user is embarking (or from which the user about to embark).

In one example use case, the ticket purchasing process 122 receives the user location information from block 210. The ticket purchasing process 122 then analyzes the received location information to make a determination as to which train station the user is embarking from. For instance, the ticket purchasing process may access a database with train station locations and then match the location information to a closest train station based on the information in the database. The scope of embodiments includes any appropriate technique to determine a train station from user location data.

In another example, there is no explicit action corresponding to block 210. Rather, the user's mobile device receives information regarding the train station by, e.g., user input, input from another device, scanning a QR code that links to information regarding the train station, communicating with an RFID tag at the train station, and/or the like. In any event, the ticket purchasing process 122 determines the user's train station using any appropriate technique to facilitate the actions of block 240 (described in detail below).

At block 230, the system determines a direction of user travel.

For instance, in one example, the user enters a direction of travel by selecting a direction of travel or destination from a list or manually entering a direction or destination city/station into a field using a ticket purchasing process 124 at the user mobile device. In another example, the user device is enabled to discern a location by GPS or other satellite-based location technique, and the user device (or other computer in communication with the user device) discerns a direction of travel by analyzing device movement as the train proceeds to leave the station and head to the next station.

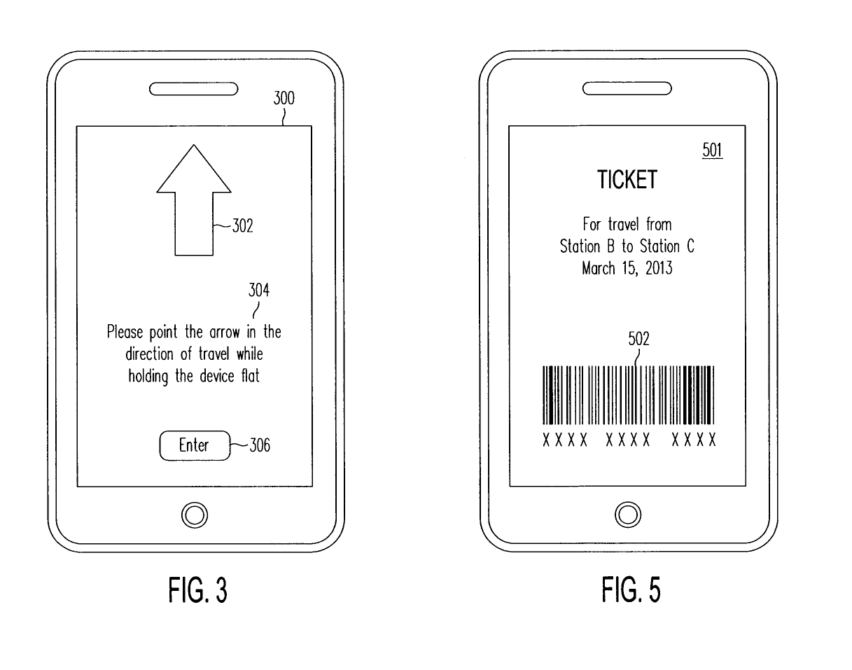

In another example, the user points the mobile device in a direction of travel. The application accesses a compass function of the mobile device to match the user's pointing to a direction of travel. FIG. 3 is an illustration of an example user interface 300 adapted according to one embodiment. Interface 300 may be rendered upon a screen of a user mobile device that includes a compass function. Interface 300 includes arrow 302 and a message 304 that instructs the user to point the arrow in the direction of travel while holding the device flat. The user may then point arrow 302 in the direction of travel by orienting the device so that the arrow 302 is approximately aligned with the expected or actual travel direction. Once the arrow is aligned, the user selects enter button 306. The user device then passes information to a computer running ticket purchasing process 122.

Continuing with the example, the ticket purchasing process 122 or 124 compares compass data with the alignment of the arrow to discern an approximate direction of travel. The user mobile device and/or a device running ticket purchasing process 124 may use any appropriate method to discern the direction of travel.

Returning to FIG. 2, at block 240 the system accesses a schedule for the station.

In one example, the ticket purchasing process 122 or 124 accesses a database of train schedules and uses the direction of travel to determine a series upcoming stops. The database may be managed by a computer associated with the PSP 118, the receiver 116, or a third party.

At block 250, the system presents a schedule on the user device.

In one example, the purchasing process 122 accesses the train schedule at block 240 and then generates data with the upcoming stops, sending that data to the purchasing process 124 on the user's mobile device. The ticket purchasing process 124 then renders the data on a screen of the mobile device. In another example, the ticket purchasing process 124 on the user's mobile device performs the action of block 240 and then renders the upcoming stops on its screen.

The action of block 250 may be performed using augmented reality in some examples. For instance, the ticket purchasing process 124 on the user device may overlay the names of the upcoming stops on a map of the train's route. FIG. 4 is an illustration of an example augmented reality interface 400 adapted according to one embodiment. Interface 400 includes a map, either a satellite photo or a non-photo map, of the train's route with stations B, C, D, and E marked prominently on the map for the user. Message 402 is overlaid on the map, and it tells the user that the train is leaving station B. Messages 404, 406, 408 are also overlaid onto the map, thereby providing an augmented reality view of the map.

Continuing with FIG. 4, message 404 informs the user that the next stop is station C, and the cost of a ticket to station C is fifty cents. The user can purchase a ticket for station C by selecting button 405. Messages 406 and 408 are similar to message 404, allowing a user to purchase a ticket for station D or station E, respectively. Interface 404 may be rendered upon the screen of the user's mobile device, and the user may interact with interface 400 while the user is on the train, or even as the train is moving as long as the user has a network connection.

In other embodiments, the augmented reality interface 400 may include other or different information than that shown in FIG. 4. For instance, messages 404, 406, 408 may include connecting trains, arrival and departure times, and other appropriate information. FIG. 4 is shown as a touchscreen-type interface, however any Graphical User Interface (GUI) that uses another pointing scheme (such as a cursor) can be adapted according to the embodiments herein.

At block 260, the system receives an indication of the destination from the user.

In one example, the user selects a destination from interface 400 by, e.g., touchscreen interaction or other pointing technique. Ticket purchasing process 124 then sends data to ticket purchasing process 122, where the data indicates the destination explicitly or impliedly by indicating a ticket selection.

At block 270, the system processes payment for a ticket to the destination.

In a scenario in which ticket purchasing process 122 is associated with the PSP 118, the PSP 118 sends a request for payment to the TFS 114. TFS 114 then schedules payment and sends a confirmation to PSP 118, which credits receiver account 121 for the purchase price. In another scenario in which ticket purchasing process 122 is associated with receiver 116, receiver 116 sends the user's account information and a transaction identification and amount to PSP 118. PSP 118 then makes a request to TFS 114 for payment. TFS 114 then schedules payment and sends a confirmation to PSP 118, and PSP 118 may send a confirmation to ticket purchasing process 122. In any event, the account 120 of the user is debited by the amount of the fare, and the account 121 of the receiver 121 is credited by the amount of the fare. Any technique of settling the transaction is within the scope of embodiments.

In some embodiments, the interface 400 is presented as a part of an account belonging to the user, where the account has stored information of the user. Thus, the user may be able to purchase tickets without manually entering electronic payment information (e.g., card number and billing address). In fact, in some embodiments the ticket purchasing functionality (including interface 400) is provided as an extension of a user account with PSP 118, where PSP 118 is already aware of the user's payment account information (e.g., credit cards and bank accounts that are linked to the user's account at PSP 118). In such an embodiment, the user may be able to purchase tickets without manually entering electronic payment information. Nevertheless, the scope of embodiments does not exclude the possibility that in some instances the user might manually enter electronic payment information as appropriate.

At block 280, the system presents an electronic ticket at the user device.

In one embodiment, once payment is confirmed ticket purchasing process 122 (either at PSP 118 or receiver 116) generates an electronic ticket and sends the electronic ticket to ticket purchasing process 124 at the user device. The user device may then present the electronic ticket upon its screen for inspection by train personnel and/or scanning by an electronic device.

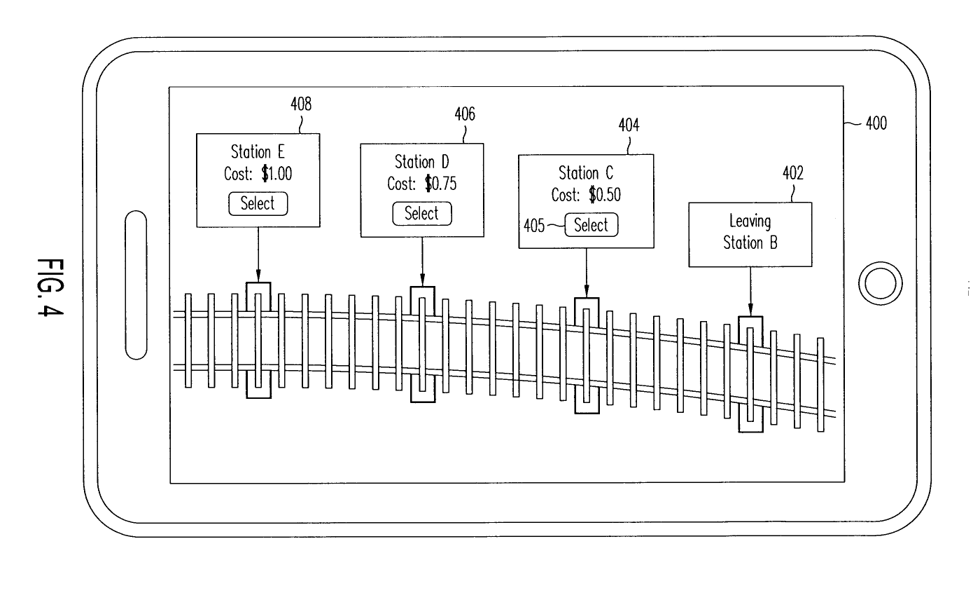

FIG. 5 is an illustration of an example electronic ticket 501 displayed upon a screen of a user mobile device. In the example of FIG. 5, the user has purchased a ticket for travel to Station D (FIG. 4). The system has generated electronic ticket 501 and sent ticket 501 over a network to ticket purchasing process 124, which displays the ticket on a screen of the user mobile device. In this example, ticket 501 also includes barcode 502, though the scope of embodiments may include any appropriate format for the ticket that may include different information.

The scope of embodiments is not limited to the particular flow shown in FIG. 2. Rather, other embodiments may add, omit, rearrange, or modify one or more actions in accordance with a given design. For instance, other embodiments may include allowing the user to purchase other kinds of tickets as well, such as tickets for connecting trips, tickets for travel within zones, monthly passes, etc.

It should be noted once again that the scope of embodiments is not limited to train tickets. The principles discussed above may be applied to other forms of transportation that have defined routes and stops, such as bus lines, tram or light rail lines, subways, and the like.

Various embodiments may provide one or more advantages over current systems. For instance, some embodiments allow a user to quickly purchase a ticket, thereby avoiding lines at a kiosk or ticket counter. Thus, various embodiments may increase the efficiency of commuting systems. An alternative solution might include installing ticket purchase machines inside trains; however, such solution would still suffer from long lines by commuters at the machines. Various embodiments of the present disclosure, by contrast, allow users to purchase tickets after having boarded and while avoiding lines. Additionally, the feature of some embodiments to use a user's location and direction of travel may assist the user in selecting tickets and provide for faster service and fewer mistakes when the user is purchasing tickets.

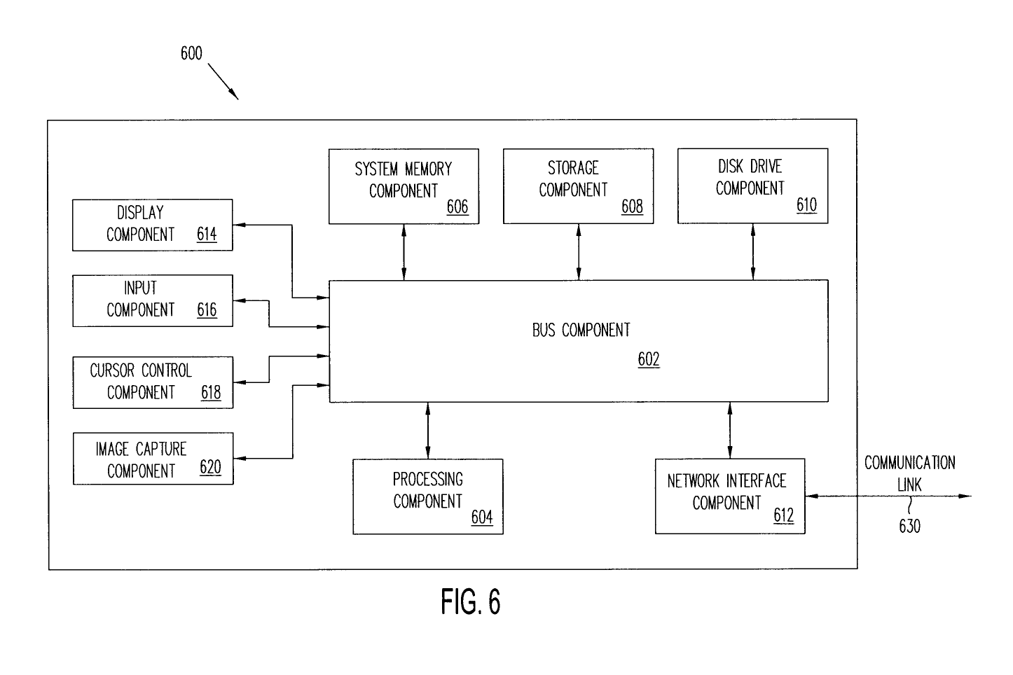

FIG. 6 is a block diagram of a computer system 600 suitable for implementing various methods and devices described herein, for example, the various methods may be performed by a server computer or other type of computer associated with a PSP, transportation service, or third party. Accordingly, it should be appreciated that such devices may be implemented as the computer system 600 for communication with a network in a manner as follows.

In accordance with various embodiments of the present disclosure, the computer system 600 includes a bus component 602 or other communication mechanisms for communicating information, which interconnects subsystems and components, such as processing component 604 (e.g., processor, micro-controller, digital signal processor (DSP), etc.), system memory component 606 (e.g., RAM), static storage component 608 (e.g., ROM), disk drive component 610 (e.g., magnetic or optical), network interface component 612 (e.g., modem or Ethernet card), display component 614 (e.g., touch-screens, cathode ray tube (CRT) displays, or liquid crystal display (LCD)), input component 616 (e.g., keyboard or touch-sensitive components operable to detect a touch by a human body), cursor control component 618 (e.g., mouse or trackball), and image capture component 620 (e.g., analog or digital camera). In one implementation, disk drive component 610 may comprise an array having one or more disk drive components or solid-state drive components.

In accordance with embodiments of the present disclosure, computer system 600 performs specific operations by processor 604 executing one or more sequences of one or more instructions contained in system memory component 606. Such instructions may be read into system memory component 606 from another computer readable medium, such as static storage component 608 or disk drive component 610. In other embodiments, hard-wired circuitry may be used in place of (or in combination with) software instructions to implement the present disclosure.

Logic may be encoded in a computer readable, non-transitory medium, which may refer to any medium that participates in providing instructions to processor 604 for execution. Such a medium may take many forms, including but not limited to, non-volatile media and volatile media. In various implementations, non-volatile media includes optical or magnetic disks, such as disk drive component 610, and volatile media includes dynamic memory, such as system memory component 606.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 630 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 600 may transmit and receive messages, data, information and instructions, including one or more programs (i.e., application code) through communication link 630 and communication interface 612. Received program code may be executed by processor 604 as received and/or stored in disk drive component 610 or some other storage component for execution. For instance, processor 604 may execute code to perform ones of the actions of process 200 (FIG. 2).

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

FIG. 7 is a simplified block diagram of an example electronic device 700 on which a human user may interact with a ticket purchasing system according to various aspects of the present disclosure. The electronic device 700 may be a user mobile device, such as a smart phone, laptop, or a tablet computer. The electronic device 700 includes an input/output interface 710. The interface 710 is operable to receive an input from a user and communicate an output to the user. In an embodiment, the input/output interface 710 includes a visual display unit, for example a touch-sensitive screen. Input/output interface 710 may display a graphical interface, such as interfaces 300 and 400 and ticket 501 of FIGS. 3, 4, and 5.

The electronic device 700 includes a transceiver 720. The transceiver 720 is operable to electronically communicate with external devices. In an embodiment, the transceiver 720 is operable to wirelessly communicate with a Wi-Fi access point, cellular towers, or other network access points and infrastructure. Though not shown here, the device 700 may also include appropriate hardware to determine a user location (e.g., GPS hardware). The electronic device 700 also includes a computer processor 730 that is operable to execute computer instructions and a memory storage 740 that is operable to store the computer instructions.

The memory storage 740 also contains a program module that is an embodiment of the application that interacts with the ticket purchasing processes at a remote server. The program module operates to provide actions such as displaying the user interfaces, interacting with the user, discerning location, and the like. As mentioned above, the actions of process 200 (FIG. 2) may be performed at least partly by action at the user mobile device; thus, processor 730 may execute code to perform one or more actions described above with respect to FIG. 2.

It should be appreciated that like reference numerals are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1-20. (canceled)

21. A system comprising:
a memory storing user account information, wherein the information comprises an account identifier for a user; and
one or more processors for
determining a transportation station for a user based on a determined location of the user through a user mobile device;
determining a direction of travel by the user;
presenting a list of destinations to the user mobile device, the list of destinations being associated with a travel schedule corresponding to the transportation station and the direction of travel;
receiving a selected destination from the list via the user mobile device; and
presenting a transportation ticket to the user mobile device, the ticket corresponding to the selected destination.

22. The system of claim 21, wherein the system is associated with a payment service provider managing an account of a seller of the ticket.

23. The system of claim 21, wherein the processor is further operable for:
receiving an indication to purchase the ticket for the selected destination from the user mobile device; and
processing a payment for the ticket.

24. The system of claim 21, wherein the direction of travel is determined by discerning a direction the user is pointing the user mobile device.

25. The system of claim 21, wherein the direction of travel is determined by discerning a direction of movement of the user mobile device.

26. The system of claim 21, wherein the direction of travel is determined by a stop along a travel route and a location of the user at the stop.

27. The system of claim 21, wherein the transportation station comprises at least one of a train station; a light rail station, and a bus station.

28. The system of claim 21, wherein the list of destinations is overlaid onto a map of a travel route of the user.

29. A non-transitory machine-readable medium comprising a plurality of machine-readable instructions which when executed by one or more processors of a server are adapted to cause the server to perform a method comprising:
determining a transportation station for a user based on a determined location of the user through a user mobile device;
determining a direction of travel by the user;
presenting a list of destinations to the user mobile device, the list of destinations being associated with a travel schedule corresponding to the transportation station and the direction of travel;
receiving a selected destination from the list via the user mobile device; and
presenting a transportation ticket to the user mobile device, the ticket corresponding to the selected destination.

30. The non-transitory machine-readable medium of claim 29, wherein the direction of travel is determined by at least one of the following techniques:
discerning a direction the user is pointing the user mobile device;
discerning a direction of movement of the user mobile device;
discerning a stop along a travel route and the location of the user.

31. The non-transitory machine-readable medium of claim 29, wherein the transportation station comprises at least one of a train station, a bus station, and a light rail station.

32. The non-transitory machine-readable medium of claim 29, wherein the method further comprises:
receiving an indication to purchase the ticket for the selected destination from the user mobile device; and
processing a payment for the ticket.

33. A method comprising:
determining a transportation station for a user based on a determined location of the user through a user mobile device;
determining a direction of travel by the user;
presenting a list of destinations to the mobile device, the list of destinations being associated with a travel schedule corresponding to the transportation station and the direction of travel;
receiving a selected destination from the list via the user mobile device; and
presenting a transportation ticket to the user mobile device, the ticket corresponding to the selected destination.

34. The method of claim 33, wherein the direction of travel is determined by discerning a direction the user is pointing the user mobile device.

35. The method of claim 33, wherein the direction of travel is determined by discerning a direction of movement of the user mobile device.

36. The method of claim 33, wherein the direction of travel is determined by a stop along a travel route and the location of the user.

37. The method of claim 33, wherein the transportation station comprises at least one of a train station, a light rail station, and a bus station.

38. The method of claim 33, further comprising:
receiving an indication to purchase the ticket for the selected destination from the user mobile device; and
processing a payment for the ticket.

39. The method of claim 33, wherein the method is performed by a payment service provider managing an account of a seller of the ticket.
